(19) United States
(12) Patent Application Publication
(10) Pub. No.: US 2016/0189158 A1
(43) Pub. Date: Jun. 30, 2016

(54) AUTHENTICATING REQUESTS TO ACCESS ACCOUNTS BASED ON PRIOR REQUESTS

(71) Applicant: EBAY INC., San Jose, CA (US)

(72) Inventors: David Edward Eramian, Mountain View, CA (US); Michael Charles Todasco, Santa Clara, CA (US)

(21) Appl. No.: 14/584,546

(22) Filed: Dec. 29, 2014

(51) Int. Cl. G06Q 20/40

(52) U.S. Cl. CPC G06Q 20/4014

(57) ABSTRACT

A system, a medium, and a method involve a communication interface of a server device that receives activity data associated with an activity of an account, where the activity data includes a payment request for a transaction between a user of the account and a merchant. A processor of the server device determines a location associated with the payment request based at least on the activity data. An authentication component of the server device accesses prior authenticated requests of the account. The authentication component determines a prior authenticated request of the account based at least on the location and a time period. The authentication component determines an authentication of the payment request based at least on the prior authenticated request and an authentication input. A transceiver of the communication interface transmits an indication of the authentication to a client device.

### TECHNICAL FIELD

This disclosure relates to determining authentications of requests to access accounts, and more particularly, to computing devices configured to determine authentications of requests based on prior requests.

### BACKGROUND

Some examples of accounts may include financial accounts, e-mail accounts, social networking accounts, e-commerce accounts, accounts with service providers, and/or other types of accounts. Various technologies may evaluate activities of an account. In some instances, passwords, ciphers, digital keys, and/or other codes may validate the activities of the account. For example, an automated teller machine (ATM) may be configured to receive ATM card data and a personal identification number (PIN) to identify a financial account and validate activities of the account. Further, a fuel dispenser machine at a gas station may be configured to receive credit card data and a zip code to identify a financial account and validate fuel purchases made with the account.

In some instances, a user may have to keep track of multiple ATM cards, credit cards, identification cards, passwords, PIN numbers, zip codes, and/or other forms of account data to validate activities of one or more accounts. In addition, the user may be required to periodically change such cards, passwords, codes, and/or accounts to prevent unauthorized activities by other users. As such, it may be necessary to keep track of multiple changes to such cards, passwords, codes, and/or accounts, possibly requiring data maintenance, security, and/or protection of such accounts. In some embodiments, various sophisticated technologies may be implemented to reduce and/or eliminate the need for such requirements.

In some instances, a thief may take possession or control of a user's credit card, ATM card, PIN number, and/or zip code to make unauthorized transactions. In such instances, fraud prevention technologies may identify the unauthorized transactions of the account and inform an authorized user of these transactions. As such, the user may take a number of steps such as submitting a claim and/or requesting reimbursement for the unauthorized transactions. In some instances, the user may be required to replace the ATM card, the credit card, the PIN number, the zip code, and/or other forms of account data to prevent unauthorized activities by others, possibly requiring data maintenance, security, and/or protection of such accounts. In some embodiments, various sophisticated technologies may be implemented to reduce and/or eliminate the need for such requirements.

### BRIEF DESCRIPTION OF THE DRAWINGS

FIG. 1 is a simplified block diagram of an example system, according to an embodiment;

FIG. 2A provides an exemplary server device configured to support a set of trays, according to an embodiment;

FIG. 2B provides an exemplary tray configured to support one or more server components, according to an embodiment;

FIG. 3 provides an exemplary system, according to an embodiment;

FIG. 4 provides an exemplary system, according to an embodiment;

FIG. 5 provides an exemplary system, according to an embodiment;

FIG. 6 is a flowchart of an exemplary method for determining an authentication of a request to access an account, according to an embodiment;

FIG. 7 provides an exemplary client device with a user interface, according to an embodiment;

FIG. 8A provides an exemplary client device, according to an embodiment;

FIG. 8B provides another exemplary client device, according to an embodiment; and

FIG. 9 is an illustration of one or more forms of biometric data, according to an embodiment.

Embodiments of the present disclosure and their advantages are best understood by referring to the detailed description that follows. It should be appreciated that reference numerals are used to identify elements illustrated in one or more of the figures, where showings therein are for purposes of illustrating embodiments of the present disclosure and not for purposes of limitation.

### DETAILED DESCRIPTION

In some embodiments, a system may determine an authentic request to access an account based on prior authenticated requests. For example, consider a scenario where a user is shopping at a mall and stops at a store to make a purchase with the user's credit card. To complete the purchase, the user may swipe the credit card along a merchant device at the store, e.g., a device configured to receive credit card data. The user may also sign the user's name on an electronic signature pad of the merchant device, thereby authenticating the user's request to complete this first purchase. In some instances, the user may then go on to other stores to make additional purchases based on completing the first purchase. Yet, the user may be able to make these purchases by simply pressing a finger on a fingerprint sensor of merchant devices in the other stores. In particular, the user may be able to make these purchases without carrying the credit card to each store, swiping the credit card for each of these purchases, and signing the user's name for each of these purchases. In some instances, the system may identify the user's presence at the shopping mall amongst a discrete number of other shoppers at the mall. Based on completing the first purchase, the system may efficiently and accurately authenticate additional purchases by the user through identifying the user's fingerprint data among other data for the discrete number of other shoppers.

In some embodiments, the system may allow the additional purchases based on locations and times associated with these purchases. For example, considering the scenarios above, the system may allow the user to make additional purchases using fingerprint scans at the mall location. The mall location may be defined by a given radius around the location of the store where the first purchase occurred. In some instances, the user may exit the given radius and the system may require the user to swipe the credit card and provide a signature for each purchase attempted outside of the given radius. In another example, the system may allow the user to make additional purchases using fingerprint scans for a given period of time after the first purchase. Further, the system may require the user to swipe the credit card and provide a signature for a purchase after the given time period. As such, the system may allow the user to make subsequent purchases using the fingerprint scans for a second period of time.

In some embodiments, the system may determine the store locations and the time periods for allowing additional purchases with the user's fingerprint scans. For example, considering the scenarios above, the system may determine the locations and the time periods based on an estimated time period the user may shop and/or be present at the mall location. Further, the system may determine the locations and the time periods based on an event at the mall location, prior events at the mall location, and/or a number of stores/merchants at the mall location, and/or other data associated with the mall location. Further, the system may determine the locations and time periods based on calendar data associated with the mall location, a sale at the mall location, sales of merchants at the mall location, a current time of the year, and/or other data related to the shopping mall.

In some embodiments, an authentication state may be determined for an account. A system may track, update, and/or adjust the authentication state of the user's account based on locations of a user's smartphone. For example, considering one or more scenarios above, the user may carry the smartphone from a shopping mall to a nearby vehicle. As such, a system may create an authentication state of the user's account based on the location of the smartphone moving from the shopping mall to the nearby vehicle. Further, the system may adjust the authentication state based on the location of the smartphone moving from the mall location to a gas station a few miles away. In some instances, the system may identify the gas station as one regularly used to purchase fuel with the user's credit card account. Thus, the system may update the authentication state accordingly. In some instances, by swiping a credit card at a fuel dispenser machine and entering a valid zip code, the system may enable the fuel dispenser machine to access the user's account for refueling the user's vehicle. Yet, based on the authentication state, the system may enable the fuel dispenser machine to access the account by the user simply entering a valid PIN number and/or pressing a finger on a fingerprint sensor of the machine, thereby circumventing the need to swipe the card at the fuel dispenser machine, let alone having to carry the card.

Further, consider another scenario where the user accidentally misplaces the credit card at the shopping mall and a thief takes possession of the card. Yet further, consider the thief attempts to make purchases using the credit card and swipes the card with a merchant device at a department store at the shopping mall. In such instances, the system may update the authentication state of the user's account based on a distance between the department store location and the user's smartphone, possibly a distance of a few miles in this scenario. The system may update the authentication state to indicate a warning or possibly a message indicating suspicious activity of the user's account. Based on the updated authentication state, the system may block the merchant device at the department store from accessing the user's account. In some instances, the system may send a request to the user's smartphone to authenticate this activity at the department store before enabling the merchant device to access the user's account and the user may decline this request, thereby blocking the device from accessing the account. As such, the system may proactively detect suspicious activities of the account to prevent unauthorized activities before they occur, thereby eliminating the need for retroactive protection of the user's account. Thus, the user may not need to submit a claim and/or request reimbursement for the unauthorized activities.

Further, considering the scenarios above, the system may enable the user to purchase fuel at the gas station based on the authentication state. Yet, considering the authentication state based on the thief attempting to make purchases using the user's credit card, the system may request biometric data from the user before enabling the user to purchase fuel. For example, the user may be required to press two fingers on a fingerprint sensor of a fuel dispenser machine to begin refueling the user's vehicle. Thus, based on the authentication state of account, the system may authenticate the user's activities of the account through biometric data, thereby allowing the user to refuel the vehicle without having possession of the credit card or any other card. As such, the system may continue authenticating the user's activities of the account while preventing unauthorized activities attempted by the thief and/or other unauthorized users.

In some embodiments, the system may determine the authentication state based on various forms of biometric data. For example, the user's smartphone may take the form of a wearable computing device such as a head-mountable display (HMD). In some instances, the HMD may include proximity sensors to detect the distance of the HMD from one or more ground surfaces, thereby estimating a height of the wearer/user of the HMD. As such, the system may update the authentication state by identifying the estimated height of the wearer as one associated with the user's account. Further, in some instances, the HMD may include various other sensors to detect the weight, size, and/or shape of the user. Yet further, the HMD may include motion sensors such as accelerometers and gyroscopes to detect movements of the user. As such, various forms of body data and movement data may be used to update the authentication state of the user's account.

In some embodiments, various types of data may include activity data, authentication data, biometric data, location data, time data, and/or other types of data. In some instances, various types of data may be represented by packets of data, possibly referred to as “data packets.” In some instances, a server may manage data packets indicative of activities of accounts, and the server may transmit data packets to a client device such as a smartphone. For example, consider one or more scenarios above where a smartphone is moved from the shopping mall location to the location of the vehicle. In such instances, a server device may receive activity data associated with the smartphone moving from the shopping mall location to the vehicle location. Further, the server device may transmit to the smartphone activity data indicating the change in locations. As such, the activity data may be shown on a display of the smartphone.

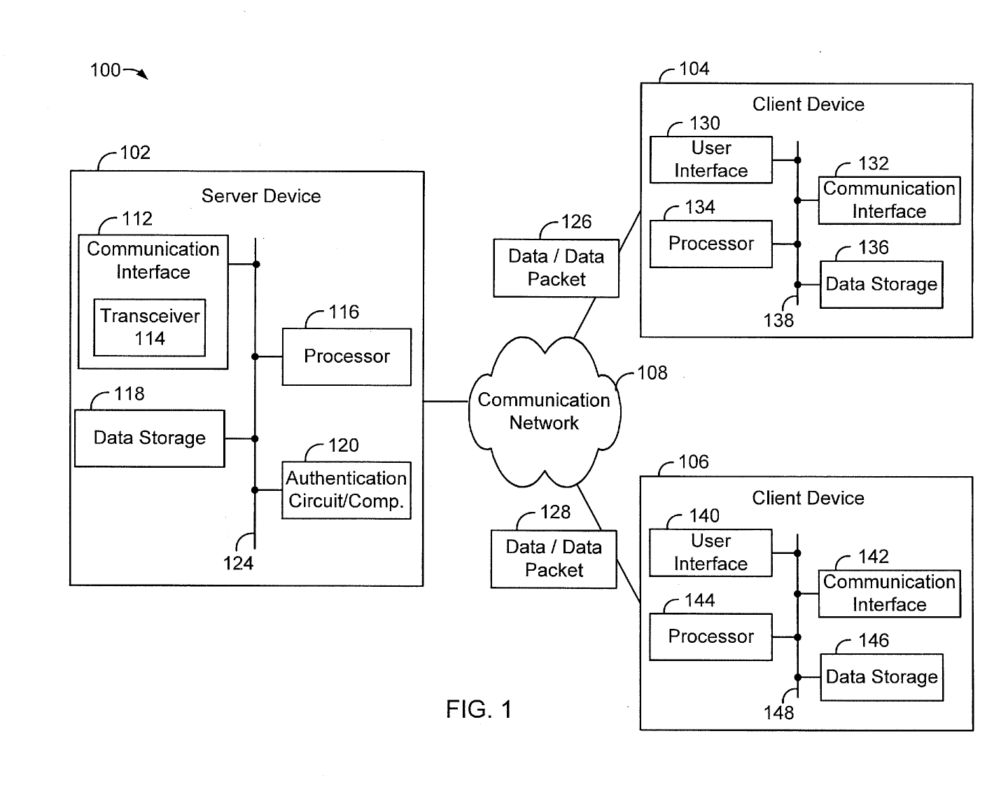

FIG. 1 is a simplified block diagram of an example system 100, according to an embodiment. As shown, system 100 includes multiple computing devices, such as a server device 102, a client device 104, a client device 106, and/or other computing devices. The server device 102 may be configured to support, operate, run, and/or manage various forms of activity data, authentication data, authentication state data, biometric data, location data, and/or other types of data. As such, also included in the system 100 is a communication network 108. The system 100 may operate with more or less than the computing devices shown in FIG. 1, possibly communicating with such devices via a communication network 108. In various embodiments, the server device 102, the client device 104, and/or the client device 106 may be configured to communicate via the communication network 108.

In some embodiments, the communication network 108 may be a packet-switched network configured to provide digital networking communications and exchange data of various forms, content, type, and/or structure. The communication network 108 may correspond to small scale communication networks, such as a private or local area network, or a larger scale network, such as a wide area network or the Internet, accessible by the various components of the system 100. The communication network 108 may include network adapters, switches, routers, network nodes, and various buffers and queues to exchange data packets. For example, the communication network 108 may be configured to exchange data packets such as a first data packet 126 and/or a second data packet 128 including activity data, authentication data, authentication state data, biometric data, location data, and/or other types of data. The communication network 108 may exchange data packets between the server device 102, the client device 104, and/or the client device 106 using various protocols such as Transmission Control Protocol/Internet Protocol (TCP/IP), among other possibilities.

In some embodiments, the system 100 may also include other computing devices and/or software configured to perform various implementations in accordance with this disclosure and illustrated by the accompanying figures. For example, the system 100 may include other client devices, servers including stand-alone and/or enterprise-class servers, servers implementing one or more operating systems such as a client- and/or server-based operating systems. It can be appreciated that the client devices and/or server devices illustrated in FIG. 1 may be deployed in other ways and that the operations performed and/or the services provided by such devices may be combined or separated for a given embodiment and may be performed by a greater number or a fewer number of client devices and/or server devices. One or more client devices and/or server devices may be operated and/or maintained by the same or different entities and/or users.

In some embodiments, the system 100 may include the server device 102 configured to perform various implementations in accordance with this disclosure and illustrated by the accompanying figures. For example, the server device 102 may be configured to receive and/or access activity data associated with various activities of an account. Further, the server device 102 may be configured to receive and/or access activity data associated with various activities of multiple accounts. For example, the server device 102 may be configured to receive and/or access location data identifying the locations of the client device 104 and/or 106.

In some embodiments, an “account” and/or a “user account” may be a compilation of data associated with activities. As noted, some examples of accounts may include financial accounts, e-mail accounts, social networking accounts, e-commerce accounts, smartphone accounts, and/or accounts with service providers, among other possibilities. For example, an account for a particular user may include data related to the user's activities and/or data representing the user. The user may provide various types of information to the account. The account may be displayed on a computing device, such as a smartphone, a laptop computer, a tablet computer, and/or a wearable computing device that may be used to access the account. The user may operate the computing device and the account may be managed on the computing device. For example, the computing device may receive data, send data, and/or store data associated with the account. Further, various details regarding a number of activities may be viewed on the computing device. Further, various types of data may be provided to authenticate activities of the account and payment information may be provided to secure transactions of the account.

In some embodiments, an account may be created by one or more users. Further, the account may be created by applications, web sites, and/or other services, for instance. Thus, various users may have access to a particular account. The user may be an entity, and/or a corporation, among other possibilities. For example, the user may be a corporation with access to a corporate account, possibly for its employees and/or contractors. Yet further, a user may be a computing device, a computing system, a robotic system, and/or another form of technology capable of sending and receiving information using the account. A user may provide a login, a password, a code, authentication data, biometric data, and/or other types of data to access the account.

In some embodiments, the account may gather data regarding the user and compile the data into the user's account. In particular, the account may track previous activities associated with the account, locations of the activities, purchases made with the account, and/or other forms of activity data indicative of future activities that may be associated with the account. Further, the account may track how long it takes the user to participate in activities such as shopping, locating items to purchase, purchasing items, and/or other activities. The account may also provide recommendations to the user based on the information stored in the user's account.

In some embodiments, a user may have a single account providing a representation of the user for various websites, applications, and/or other services. For example, a user could opt to use their e-mail account or social network account as a multi-purpose account to use and/or access financial accounts, e-commerce accounts, service accounts and/or other types of accounts. For example, a single account may be used to perform various activities and/or services. In some instances, the account may track locations of the user, enable withdrawals and/or deposits of cash via an ATM machine, allow purchasing of store items, and/or enable other activities. In some instances, the user may be prompted for various types of authentication data and provide the requisite data to proceed with the account activities.

In some embodiments, the server device 102 may take a variety of forms and may include various components, including for example, a communication interface 112, a transceiver 114, a processor 116, a data storage 118, an authentication circuit/component 120, and/or other circuits/components, any of which may be communicatively linked to the other modules via a system bus, network, or other connection mechanism 124.

The communication interface 112 may take a variety of forms and may be configured to allow the server device 102 to communicate with one or more devices according to any number of protocols. For example, the communication interface 112 may include the transceiver 114 configured to allow the server device 102 to communicate with the client devices 104 and/or 106 via communication network 108. In one example, the communication interface 112 and/or the transceiver 114 may take the form of a wired interface, such as an Ethernet interface. As another example, the communication interface 112 and/or the transceiver 114 may take the form of a wireless interface, such as a cellular interface, a WI-FI interface, and/or another short-range, point-to-multipoint voice and/or data transfer communication interface, such as BLUETOOTH. In some instances, the communication interface 112 may send/receive activity data to/from client devices 104 and/or 106.

The processor 116 may include or take the form of a general purpose processor, e.g., a microprocessor. Further, the processor 116 may include or take the form of a special purpose processor such as a digital signal processor (DSP), an application specific integrated circuit (ASIC), a programmable system on chip, and/or another processing component configured to process activity data, authentication data, biometric data, location data, and/or other types of data. As such, the processor 116 may receive data and/or data packets 126 and 128 via the communication network 108. Further, the processor 116 may access data and/or data packets 126 and 128 received by the server device 102. For example, the data packets 126 and 128 may be transmitted over communication network 108. Further, the data packets 126 and/or 128 may include IP addresses of client device 104 and 106, respectively. Yet further, the data packets 126 and/or 128 may also include data in protocols such as Transmission Control Protocol/Internet Protocol (TCP/IP). In various embodiments, each of packets 126 and 128 may include 1,000 to 1,500 bytes, among other possible data capacity ranges.

The processor 116 may determine one or more locations of activities from activity data. Further, the processor 116 may determine that activity data includes authentication data such as biometric data. In some instances, the processor 116 may include pre-configured and/or dedicated circuits of server device 102. Further, the processor 116 may include circuits and/or hardware components configured to carry out operations in accordance with this disclosure and illustrated by the accompanying figures. For example, the processor 116 may determine from the data 126 a first location of a first activity. Yet further, the processor 116 may determine from the data 128 a second location of a second activity.

The data storage 118 may include one or more volatile, non-volatile, removable, and/or non-removable storage components, such as magnetic, optical, or flash storage, and may be integrated in whole or in part with processor 116. Further, the data storage 116 may include or take the form of a non-transitory computer-readable storage medium, having stored thereon machine-readable instructions such as compiled or non-compiled program logic and/or machine code that, when executed by server device 102, cause the server device 102 to perform operations, such as those described in this disclosure and illustrated by the accompanying figures.

The authentication circuit and/or component 120 may access prior authenticated requests of an account and determine a prior authenticated request of the account based on location and time. The authentication circuit and/or component 120 may determine an authentication state of an account based on activity data. Further, the authentication circuit and/or component 120 may determine authentications of activities. For example, the authentication circuit and/or component 120 may determine authentications of payment requests. Further, the authentication circuit and/or component 120 may determine authentications of payment requests based on various authentication states of the account. The authentication circuit and/or component 120 may also determine one or more forms of biometric data to authenticate activities of accounts. In some instances, the authentication circuit and/or component 120 may include pre-configured circuits, dedicated circuits, and/or hardware components of server device 102 to determine authentication states, authentication data, relationships, one or more forms of biometric data, authentications of activities, and/or other data related to authenticating activities of accounts. Further, the authentication circuit and/or component 120 may include circuits and/or hardware components configured to carry out operations in accordance with this disclosure and illustrated by the accompanying figures. For example, the authentication circuit and/or component 120 may determine a first authentication of a first activity based on the first activity data 126 and a second authentication of a second activity based on the second activity data 128.

As with server device 102, client devices 104 and 106 may be configured to perform a variety of operations such as those described in this disclosure and illustrated by the accompanying figures. For example, client devices 104 and 106 may be configured to exchange activity data with the server device 102 such as data 126 and 128 indicating activities associated with accounts. Client devices 104 and 106 may take a variety of forms, including for example, a personal computer (PC), a smartphone, a wearable computer, a laptop/tablet computer, a merchant device, a smart watch with appropriate computer hardware resources, a head-mountable display, an arm-mountable display, other types of wearable devices, and/or other types of computing devices capable of transmitting and/or receiving data, among other possibilities. Client devices 104 and 106 may include various components, including, for example, user interfaces 130 and 140, communication interfaces 132 and 142, processors 134 and 144, and/or data storages 136 and 146, respectively, all of which may be communicatively linked with each other via a system bus, network, or other connection mechanisms 138 and 148, respectively.

User interfaces 130 and 140 may be configured for facilitating interaction between the client devices 104 and 106 and users of the client devices 104 and 106, respectively. For example, user interfaces 130 and/or 140 may be configured to receive inputs from respective users and providing outputs accordingly. In some instances, the user interfaces 130 and 140 may include input components such as a touchscreen, a touch sensitive panel, a microphone for receiving voice commands, a computer mouse, a keyboard, and/or other input components. In addition, user interfaces 130 and 140 may include output components such as displays possibly with touchscreen inputs, a sound speaker and/or other audio output mechanism, a haptic feedback system, and/or other output components.

In some embodiments, communication interfaces 132 and 142 may take a variety of forms and may be configured to allow client devices 104 and 106, respectively, to communicate with one or more devices according to any number of protocols. For instance, communication interfaces 132 and 142 may be configured to allow client devices 104 and 106, respectively, to communicate with the server device 102 via the communication network 108.

Processors 134 and 144 may include general purpose processors and/or special purpose processors. Data storages 136 and 146 may include one or more volatile, non-volatile, removable, and/or non-removable storage components, and may be integrated in whole or in part with processors 134 and 144, respectively. Further, data storages 136 and 146 may take the form of non-transitory computer-readable storage mediums, having stored thereon machine-readable instructions that, when executed by processors 134 and 144, cause client devices 104 and 106 to perform operations, respectively, such as those described in this disclosure and illustrated by the accompanying figures. Such machine-readable instructions may define or be part of a discrete software application, such a native app and/or web app that can be executed upon user input.

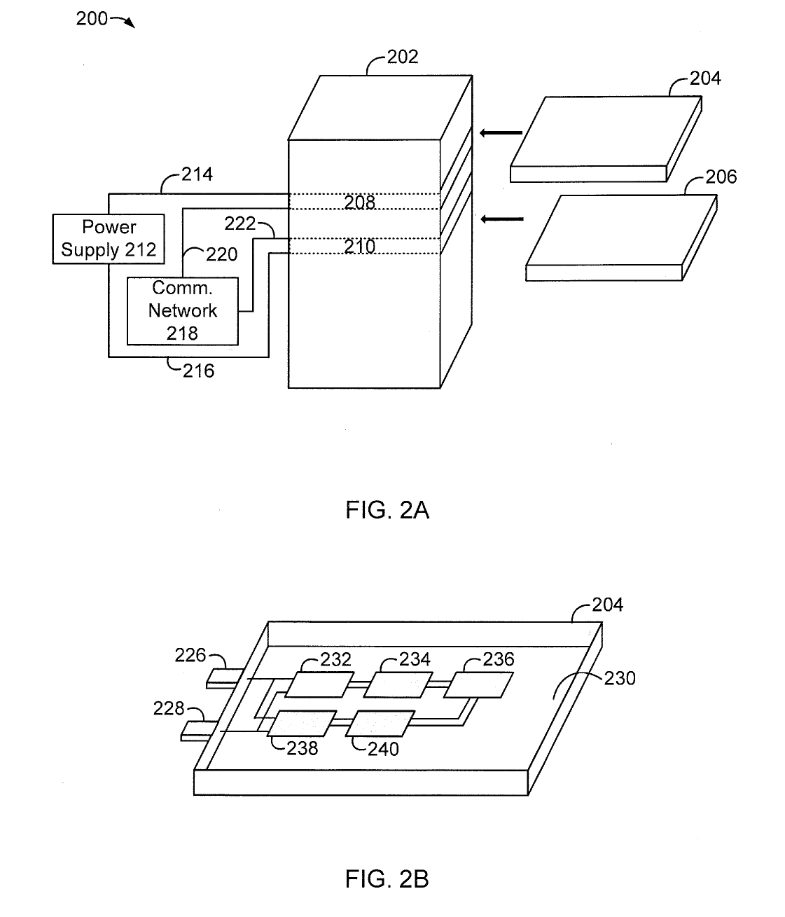

FIG. 2A is an exemplary server device 200 configured to support a set of trays, according to an embodiment. The server device 200 may, for example, take the form of the server device 102 described above in relation to FIG. 1. Further, the server device 200 may be configured to support, operate, run, and/or manage activity data, authentication data, biometric data, location data, and/or other types of data.

As shown, the server device 200 may include a chassis 202 that may support trays 204 and 206, and possibly multiple other trays as well. The chassis 202 may include slots 208 and 210 configured to hold the trays 204 and 206, respectively. For example, the tray 204 may be inserted into the slot 208 and the tray 206 may be inserted into the slot 210. Yet, the slots 208 and 210 may be configured to hold the trays 204 and 206 interchangeably such that the slot 208 may be configured to hold the tray 206 and the slot 210 may be configured to hold the tray 204. For example, the tray 204 may be inserted into the slot 208 and the tray 206 may be inserted into the slot 210. Further, during operation of the server device 200, the trays 204 and 206 may be removed from the slots 208 and 210, respectively. Yet further, the tray 204 may be inserted into the slot 210 and the tray 206 may be inserted into slot 208, and the server device 200 may continue various operations.

The chassis 202 may be connected to a power supply 212 via connections 214 and 216 to supply power to the slots 208 and 210, respectively. The chassis 202 may also be connected to communication network 218 via connections 220 and 222 to provide network connectivity to the slots 208 and 210, respectively. As such, trays 204 and 206 may be inserted into slots 208 and 210, respectively, and power supply 212 may supply power to trays 204 and 206 via connections 214 and 216, respectively. Further, trays 204 and 206 may be inserted into slots 210 and 208, respectively, and power supply 212 may supply power to trays 204 and 206 via connections 216 and 214, respectively. Yet further, trays 204 and 206 may be inserted into slots 208 and 210, respectively, and communication network 218 may provide network connectivity to trays 204 and 206 via connections 220 and 222, respectively. In addition, trays 204 and 206 may be inserted into slots 210 and 208, respectively, and communication network 218 may provide network connectivity to trays 204 and 206 via connections 222 and 220, respectively.

The communication network 218 may, for example, take the form of communication network 108 described above in relation to FIG. 1. In some embodiments, communication network 218 may provide a network port, a network hub, a network switch, or a network router that may be connected to a telephone, Ethernet, or an optical communication link, among other possibilities.

FIG. 2B illustrates an exemplary tray 204 configured to support one or more server components, according to an embodiment. The tray 204 may, for example, take the form of tray 204 described above in relation to FIG. 2A. Further, the tray 206 may also take the form of the tray 204. As shown in FIG. 2B, the tray 204 may include a tray base 230 that may be the bottom surface of the tray 204 configured to support multiple circuits and/or circuit components such as a main computing board connecting various other components. The tray 204 may include a connector 226 that may link to the connections 214 or 216 to supply power to the tray 204. The tray 204 may also include a connector 228 that may link to the connections 220 or 222 to provide network connectivity to the tray 204. The connectors 226 and 228 may be positioned on the tray 204 such that upon inserting the tray 204 into the slot 208, the connectors 226 and 228 couple directly with the connections 214 and 220, respectively. Further, upon inserting tray 204 into slot 210, connectors 226 and 228 may couple directly with connections 216 and 222, respectively.

The tray 204 may include components 232, 234, 236, 238, and 240. In some instances, a communication interface 232, a transceiver 234, a processor 236, data storage 238, and an authentication circuit and/or component 240 may, for example, take the form of the communication interface 112, the transceiver 114, the processor 116, the data storage 118, and the authentication circuit and/or component 120, respectively. As such, the tray 204 may provide power and network connectivity to each of components 232-240. In some embodiments, one or more of the components 232-240 may be provided via one or more circuits and/or components that include resistors, inductors, capacitors, voltage sources, current sources, switches, logic gates, registers, and/or a variety of other circuit elements. One or more of the circuit elements in a circuit may be configured to provide the circuit(s) that cause one or more of the components 232-240 to perform the operations described herein. As such, in some embodiments, preconfigured and dedicated circuits may be implemented to perform the operations of the components 232-240. In other embodiments, a processing system may execute instructions on a non-transitory, computer-readable medium to configure one or more circuits to perform operations described herein and illustrated by the accompanying figures.

Any of the circuits and/or components 232-240 may be combined to take the form of one or more general purpose processors, microprocessors, and/or special purpose processors, among other types of processors. For example, one or more of the communication interface 232, the transceiver 234, the processor 236, the data storage 238, and the authentication circuit and/or component 240 may be combined, possibly such that the communication interface 232, the transceiver 234, the data storage 238, and the authentication circuit and/or component 240 are combined with or within the processor 236. Further, the combined processor 236 may take the form of one or more processors, microprocessors, special purpose processors, DSPs, GPUs, FPUs, network processors, and/or ASICs, among other types of processing components. Yet further, the combined processor 236 may be configured to carry out various operations of the communication interface 232, the transceiver 234, the data storage 238, and the authentication circuit and/or component 240.

In some embodiments, a system may include a communication interface 232 of the server device 202 that receives activity data associated with an activity of an account, where the activity data includes a payment request for a transaction between a user of the account and a merchant. The processor 236 of the server device 202 may determine a location associated with the payment request based at least on the activity data. The authentication circuit and/or component 240 of the server device 202 may access prior authenticated requests of the account. The authentication circuit and/or component 240 may determine a prior authenticated request of the account based at least on the location and a time period. The authentication circuit and/or component 240 may determine an authentication of the payment request based at least on the prior authenticated request and an authentication input. The transceiver 234 of the communication interface 232 may transmit an indication of the authentication to a client device, e.g., a user's smartphone and/or a merchant device.

In some embodiments, a system may include a non-transitory computer-readable medium having stored thereon machine-readable instructions that, when executed by the server device 202, cause the server device 202 to perform operations. The communication interface 232 of the server device 202 may receive activity data associated with an activity of an account, where the activity data includes a request to access the account and biometric data to authenticate the request. The authentication component 240 may determine a prior authenticated request to access the account within a time period. The authentication circuit and/or component 240 may determine an authentication state of the account based on at least one of the prior authenticated request and the biometric data. The authentication circuit and/or component 240 may determine an authentication of the request to access the account based at least on the authentication state of the account. The transceiver 234 of the communication interface 232 may transmit an indication of the authentication of the request to a client device, e.g., a user's smartphone and/or a merchant device.

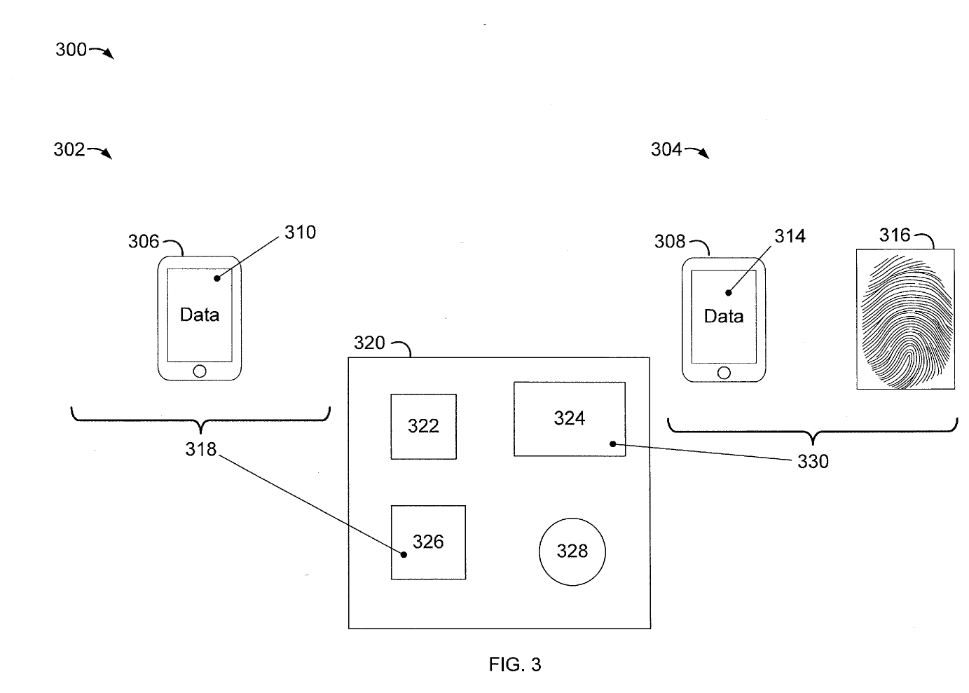

FIG. 3 is an exemplary system 300, according to an embodiment. As shown, activity 302 may involve a user at a shopping mall. Considering one or more scenarios above, the user may stop at a location 318 in a store in structure 326 to make a purchase with the user's credit card. To complete the purchase, the user may swipe the credit card along a merchant device 306 at the store in the structure 326 and sign the user's name on an electronic signature pad of the merchant device 306, thereby authenticating the user's request to complete this first purchase. As shown, the activity data 310 may include the credit card data and the signature data from the user. In some instances, the user may then go on to other stores in the structures 322, 324, and/or 328 to make additional purchases based on completing the first purchase. Yet, the user may be able to make these additional purchases by simply pressing a finger on a fingerprint sensor of merchant devices such as merchant device 308 in another store in the structure 324.

As shown, the merchant device 308 in the store in the structure 324 may receive biometric data 316. In particular, the user may be able to make additional purchases without carrying the credit card to each store in the structures 322, 324, 326, and/or 328, swiping the credit card for each purchase, and signing the user's name for each purchase. In some instances, the system 300 may identify the user's presence at the shopping mall amongst a discrete number of other shoppers at the mall. Based on completing the first purchase, the system 300 may efficiently and accurately authenticate additional purchases by the user through identifying and/or recognizing the user's fingerprint data among the discrete number of other shoppers.

In some embodiments, the system 300 may include a communication interface, a transceiver, a processor, data storage, and/or an authentication circuit/component of a server device that may take the form of the communication interfaces 112 and/or 232, the transceivers 114 and/or 234, the processors 116 and/or 236, the data storage 118 and/or 238, and/or the authentication circuit/component 120 and/or 240 of the server devices 100 and/or 200, respectively, described above in relation to FIGS. 1-3. The client devices 306 and 308 may, for example, take the form of any of the client devices 104 and 106, respectively, described above in relation to FIGS. 1-2. Thus, the activity data 310 and 314 may be displayed on the user interfaces 130 and/or 140, respectively. Thus, the user interfaces 130 and 140 may include display components configured to display the activity data 310 and 314, respectively.

In some embodiments, the communication interface of a server device receives activity data 314 associated with an activity 304 of an account, where the activity data 314 includes a payment request for a transaction between a user of the account and a merchant, possibly the merchant in a store of the structure 324. As shown, the activity data 314 may include the biometric data 316 such as fingerprint data from the user pressing a finger on a fingerprint sensor of the merchant device 308.

In some embodiments, the processor of the server device may determine a location 330 associated with the payment request based at least on the activity data 314. The location 318 and the location 330 may be shown on the map 320 for illustrative purposes. In some instances, the processor may determine location 330 from the activity data 314 including GPS data indicative of the location 330 in a store in the structure 324. Further, the processor may determine the activity data 314 includes biometric data 316 to authenticate the activity 304 including the payment request.

In some embodiments, the authentication component of the server device may access prior authenticated requests of the account. For example, the authentication component may perform searches for the prior authenticated requests of the account stored in data storage such as the data storage 118 and/or 238 described above in relation to FIGS. 1-2. In some instances, the authentication component may perform searches on the prior authenticated requests based on the location 330. Further, the authentication component may search the prior authenticated requests based on the location 318, store locations in the structures 322, 324, 326, and/or 328, and/or other locations proximate to the mall location. Further, the authentication component may perform searches on the prior authenticated requests based on a time period. For example, the authentication component may search the prior authenticated requests based on a time period after the activity 302 including the user swiping the credit card through the merchant device 306 at the store in the structure 326 and/or signing the user's name on the electronic signature pad.

In some embodiments, the authentication component may determine a prior authenticated request of the account based at least on the location and a time period. For example, the authentication component may determine the prior authenticated request from a number of prior authenticated requests accessed from the data storage such as the data storage 118 and/or 238. In some instances, the authentication component may determine the prior authenticated request based on the location 330 and/or the store in the structure 324. In some instances, the authentication component may determine the prior authenticated request based on a time period such as the time period described above in relation to the activity 302.

In some embodiments, the authentication component may determine an authentication of the payment request based at least on the prior authenticated request and an authentication input. For example, the authentication component may determine the authentication based on the prior request authenticated at the location 330, the store in the structure 324, one or more locations proximate to the location 330, one or more locations within a radius of the location 330, and/or other locations. Further, the authentication component may determine the authentication based on the server device receiving the payment request within a given time period after activity 302. Yet further, the authentication component may determine the authentication based on the authentication input received via the merchant device 308. The authentication input may include biometric data 316 such as fingerprint data from the user pressing one or more fingers on a fingerprint sensor of the merchant device 308 at the store in the structure 324. The transceiver of the communication interface may transmit an indication of the authentication to a client device such as the merchant device 308 and/or the user's smartphone.

In some embodiments, multiple stores may be in the structures 322, 324, 326, and/or 328. For example, consider one scenario where the structure 326 includes a movie theatre. In some instances, based on a first purchase of movie tickets using a credit card, the user may make additional purchases at concession stands in the structure 326 by pressing one or more fingers on the merchant devices at the concession stands. As such, the user may complete additional purchases throughout the movie theatre without using the credit card. In particular, the system 300 may identify the patrons at the movie theatre based on the number of movie tickets sold. As such, the system 300 may efficiently and accurately authenticate additional purchases by the user through recognizing the user's fingerprint data among the discrete number of other patrons.

In some embodiments, the authentication input may include biometric data 316 such as fingerprint data received from a fingerprint scan of the user. Yet further, the authentication input may include eye data, voice data, height data, weight data, and/or other body data of the user and/or other authorized users. In some instances, the user may provide the authentication input including a combination of the one or more forms of biometric data.

In some embodiments, the processor of the server device may determine a time associated with the payment request based at least on the activity data 314. For example, the activity data 314 may indicate one or more times of the activity 304 such as the time the payment request was generated, sent, and/or received by the merchant device 308. The authentication component may determine the time is within the time period associated with the prior authenticated request. For example, the time of the activity 304 may be within the time period of a few minutes after the prior authenticated request of the activity 302. Further, the time of the activity 304 may be within the time period of one or more hours, days, months, and/or years after the prior authenticated request from the activity 302. The authentication component may determine the authentication of the payment request based on the determination of the time within the time period.

In some embodiments, the authentication component may determine the time period based on at least one of an estimated time period for the user to shop at the location 330 and/or the stores in the structures 322, 324, 326, and/or 328. The estimated time period may be based on prior user visits to the location 330 and/or the stores. The time period may be determined based on an event at the location 330 and/or the stores, a prior event at the location 330 and/or the stores. Further, the time period may be determined based on a number of merchants at the location 330 and/or the stores such that the time period may be proportional to the number of merchants. Further, the time period may be determined based on calendar data associated with the location 330 and/or the stores, sales of merchants at the location 330 and/or the stores, a current time of a year, and/or other factors. For example, the user may have calendar data stored to the user's account indicating the current time of the year for holiday shopping. Further, the time period may be determined based on a current time, a current date, a current day of a week, a current month, a current season, a time of a future event, a date of the future event, a day of the future event, a month of the future event, and/or a season of the future event. In some instances, the time period may be based on the current time indicating a popular time for purchasing items from the stores in the structures 322, 324, 326, and/or 328. Further, the time period may be determined based on a time of a past event such as past purchases associated with the account, a date of the past event such as a past sale event, a day of the past event, a month of the past event, and/or a season of the past event.

In some embodiments, the time period may be determined based on a current location 330, a past location 318, a future location, a location between the merchant device 308 and the user of the account, an ambient temperature, a weather forecast at the current location 330, a weather forecast proximate to a planned location of a planned event, a past weather forecast proximate to a past location 318 of the past event, information on a calendar associated with the account, information accessible via a social networking account associated with the account, the biometric data 316 associated with the account, noise level or any recognizable sounds detected by a user's smartphone, other client devices such as the merchant devices 306 and/or 308, the other client devices proximate to the user's smartphone, and the other client devices available to communicate with the server device.

In some embodiments, the authentication component may determine the location 330 of the activity 304 includes a historical location associated with the account. For example, location data such as GPS data from the activity data 314 may indicate the historical location associated with the account. Further, the location 330 may include a store location in the structure 324 associated with the user's account, possibly a store where the user may have made one or more purchases in the past. Further, the authentication component may determine the authentication of the payment request based at least on the historical location. As such, the authentication component may determine the authentication includes a successful authentication of the payment request. In some instances, the transceiver of the communication interface may transmit an indication of the successful authentication to a client device such as the merchant device 308 and/or the user's smartphone.

In some embodiments, the authentication component may determine the location 330 associated with the payment request includes a new location associated with the account. For example, location data such as GPS data from the activity data 314 may indicate the new location associated with the account. In some instances, the authentication component may determine the authentication of the payment request based at least on the new location. As such, the authentication component may determine the authentication of the payment request includes a failed authentication of the payment request. In some instances, the transceiver of the communication interface may transmit an indication of the failed authentication to a client device such as the merchant device 308 and/or the user's smartphone. In such instances, the user may be required to swipe the credit card along the merchant device 308 to successfully authenticate the payment request.

In some embodiments, the communication interface may receive first activity data 310 associated with a first activity 302 and second activity data 314 associated with a second activity 304 of the account. The authentication component may determine an authentication state based on at least one of the location 330, the time period, and the second activity data 314. In some instances, the authentication state of the account may indicate a probability that an authorized user initiated the payment request. The probability may be based on the location 330, the time of the activity 304 within the time period, and the second activity data 314 including the biometric data 316. Further, the authentication component may determine an authentication of the second activity 304 based at least on the authentication state of the account.

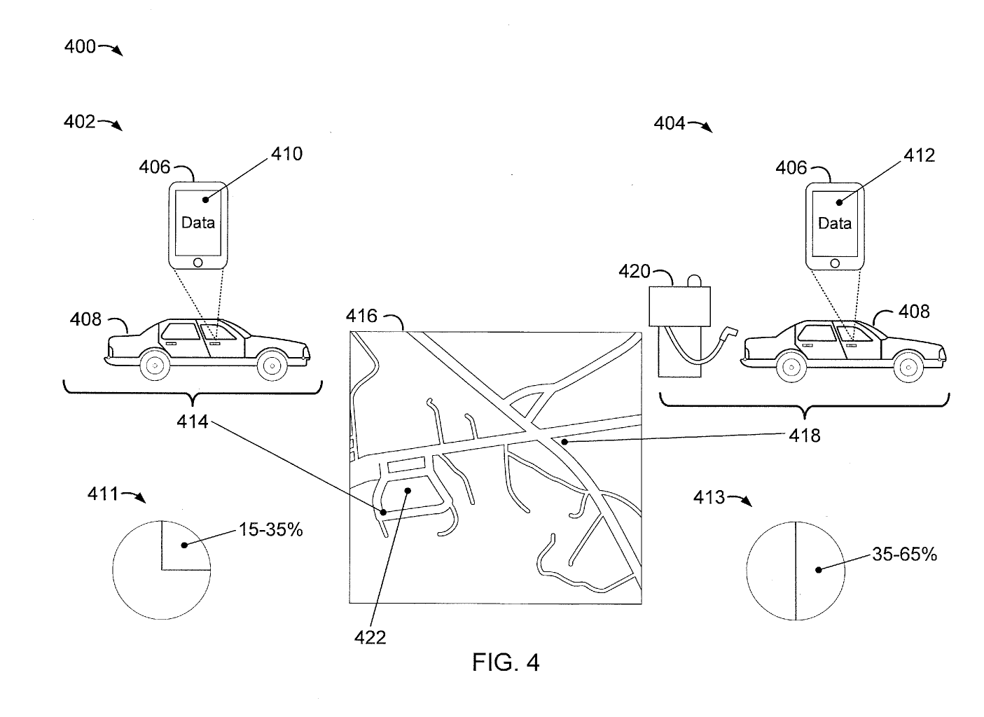

FIG. 4 is an exemplary system 400, according to an embodiment. As shown, activities 402 and 404 may involve a smartphone 406 and a vehicle 408. For example, considering one or more of the scenarios above, the system 400 may determine the activity 402 of a user leaving a shopping mall location such as the locations 318 and/or 330 described above in relation to FIG. 3. For instance, the user may carry the smartphone 406 to the vehicle 408 in the shopping mall parking lot. Further, the activity 402 may include the user accessing and/or entering the vehicle 408 at a location 414 provided on a map 416 for illustrative purposes. The smartphone 406 may, for example, take the form of any of the client devices described above in relation to FIGS. 1-2B, For example, the client device 406 may take the form of client device 104 such that activity data 410 may be displayed on the user interface 130. Thus, the user interface 130 may include a display component configured to display the activity data 410.

In some embodiments, the system 400 may include a non-transitory computer-readable medium may have stored thereon machine-readable instructions that, when executed by a server device, cause the server device to perform operations. The server device may include a communication interface, a transceiver, a processor, data storage, an authentication circuit/component of a server device that may take the form of the communication interfaces 112 and/or 232, the transceivers 114 and/or 234, the processors 116 and/or 236, the data storage 218 and/or 238, and the authentication circuit/component 120 and/or 240 of the server devices 100 and/or 200, respectively, described above in relation to FIGS. 1-2B.

In some embodiments, the operations may include the communication interface of the server device receiving the activity data 410 associated with an activity 402 of an account, where the activity data 410 may include a request to access the vehicle 408 and/or the user's account, and biometric data to authenticate the request. For example, the activity data 410 may include location data such as GPS data indicative of the location 414 and/or the location of the vehicle 408. Further, the activity data 410 may include other data associated with the vehicle 408 such as BLUETOOTH data pairing the smartphone 406 with the vehicle 408, and/or other data related to the activity 402. Yet further, the activity data 410 may include height data, weight data, body data, and/or movement data of the user as described above.

In some embodiments, the processor of the server device may determine a location 414 of the activity 402 from the activity data 410. As noted, the location 414 and the location 418 may be shown on the map 416 for illustrate purposes. In some instances, the location 414 may be a few miles away from the location 418. Further, the processor of the server device may determine the activity data 410 includes biometric data to authenticate the activity 402. In some embodiments, the authentication component of the server device may determine the biometric data includes at least one of height data, weight data, body data, and/or movement data.

In some embodiments, the authentication component may determine a prior authenticated request to access the account within a time period. For example, the authentication component may determine the prior authenticated request from a number of the prior authenticated requests accessed and/or stored in the data storage such as the data storage 118 and/or 238. For instance, the prior authenticated request may include one or more prior authenticated requests described above in relation to FIG. 3. In some instances, the authentication component may determine the prior authenticated request based on a time period such as a time period after the activity 304 and/or between the activity 304 and the activity 402.

In some embodiments, the authentication component of the server device may determine an authentication state 411 of the account based on at least one of the prior authenticated request and the biometric data. For example, the authentication component may determine the authentication state 411 based on the prior authenticated requests described above in relation to FIG. 3. Further, the authentication state 411 may be determined based on the activity data 410, the location 414, and the biometric data that may include height data, weight data, body data, and/or movement data of the user. The authentication component of the server device may determine the authentication state 411 based on the activity data 410 and/or GPS data from the activity data 410 indicative of the location 414. As shown, the authentication state 411 may be represented as a pie chart, a doughnut chart, a polar area diagram, a ring chart, a sunburst chart, a bar graph, and/or other types of statistical charts and graphs. Further, the authentication state 411 may be represented with approximately 15-35% of the chart filled indicating a lower authentication level.

In some instances, the authentication component may determine the authentication state 411 based on the user leaving the shopping mall location and carrying the smartphone 406 to the vehicle 408. In some instances, the authentication component may determine a walking path the user takes to leave the shopping mall location and reach the vehicle 408. In some instances, the authentication component may determine the authentication state 411 based on the biometric data including the height data of the user. In some instances, the client device 406 may take the form of an HMD that includes proximity sensors to detect the distance of the HMD from one or more ground surfaces, indicating a height of the wearer/user of the HMD. As such, the authentication component may determine the authentication state 411 based on identifying the height of the wearer as one stored/recorded with the user's account.

In some embodiments, the authentication component of the server device may determine an authentication of the request to access the vehicle 408 and/or the account based on the authentication state 411 of the account. In some embodiments, the transceiver of the communication interface may transmit an indication of the authentication to a client device such as the smartphone 406.

In some embodiments, the authentication component may determine the authentication state 411 meets an authentication level. The authentication level may include one or more authentication thresholds to authenticate activities. Further, the authentication component may determine the authentication is a successful authentication of the activity 402 based at least on the authentication state 411 meeting or exceeding the authentication level. For example, the authentication level may include an approximate 15-35% authentication level required to authenticate the activity 402. As such, the authentication state 411 may meet or exceed the approximate 15-35% authentication level to authenticate the activity 402. In some instances, the transceiver of the communication interface may transmit an indication of the successful authentication to a client device such as the smartphone 406.

In some embodiments, the authentication component may determine the authentication state 411 is below an authentication level. As noted, the authentication level may include one or more authentication thresholds to authenticate activities. Further, the authentication component may determine the authentication is a failed authentication of the activity 402 based at least on the authentication state 411 being below the authentication level. For example, the authentication level may indicate an approximate 15-35% level required to authenticate the activity 402. As such, the authentication state 411 may be below the approximate 15-35% authentication level to authenticate the activity 402. In some instances, the transceiver of the communication interface may transmit an indication of the failed authentication to a client device such as the smartphone 406.

In some embodiments, the authentication component may determine the location 414 of the activity includes a historical location associated with the account. For example, the location 414 may include a shopping mall parking lot location associated with the user's account. Further, the authentication component may determine the authentication state 411 of the account based at least on the historical location such as the parking lot location. As such, the authentication component may determine the authentication includes a successful authentication of the activity 402. In some instances, the transceiver of the communication interface may transmit an indication of the successful authentication to a client device such as the smartphone 406.

In some embodiments, the authentication component may determine one or more locations of the activity 402 includes a new location 422 associated with the account. Considering one or more scenarios above, a thief may take the user's credit card and swipe the card along a merchant device of a department store located at the new location 422. Further, location data such as GPS data from the merchant device may indicate the new location 422 associated with the account that may be less than a mile away from location 414. In some instances, the authentication component may determine the authentication state 411 of the account based at least on the new location 422.

For example, the authentication state 411 may indicate an authentication level be below the approximate 15-35% authentication level to authenticate the activity 402 including the thief's attempt to access the account. In some instances, the authentication component may determine the authentication includes a failed authentication of the activity 402 including the attempt to access the account. In some instances, the transceiver of the communication interface may transmit an indication of the failed authentication to a client device such as the smartphone 406. In some instances, the system 400 may send a request to the user's smartphone 406 to access the account for making a purchase at the department store and the user may decline this request. In some instances, other activities of the user's account may continue to be authenticated.

In some embodiments, the communication interface may receive second activity data 412 associated with a second activity 404 of the account. The second activity data 412 may include data indicative of an attempt to purchase fuel via a fuel dispenser machine 420 of a gas station. Further, the second activity data 412 may include GPS data indicative of the location 41 and contact data of the gas station including address and phone data of the gas station. As such, the processor of the server device may determine a second location 418 of the second activity 404 from the second activity data 412.

In some embodiments, the authentication component may determine a second authentication state 413 based on at least one of the authentication state 411 and the second activity data 412. For example, the second authentication state 413 may indicate an approximate 35-65% authentication level to authenticate the activity 404. Further, the second authentication state 413 may include the approximate 15-35% authentication level of the authentication state 411 disclosed above. In some instances, the authentication component may determine an authentication of the second activity 404 based at least on the second authentication state 413 of the account. For example, the authentication component may determine a successful authentication of the user's account to purchase fuel via the fuel dispenser machine 420. The indication of the successful authentication may be transmitted to a client device such as the smartphone 406 and/or the fuel dispenser 420.

In some embodiments, the authentication component may authenticate various activities of the activities 402 and 404. For example, the authentication component may determine the authentication state 411 meets an authentication level of approximately 15-35% to authenticate the activity 402 of the user accessing the vehicle 408. Further, the authentication component may determine the second authentication state 413 meets an authentication level of approximately 35-65% to authenticate the activity 404 of refueling the vehicle 408 via the fuel dispenser machine 420. As noted, the authentication level of 15-35% for authenticating the user entering the vehicle 408 may be lower than the authentication level of 35-65% for authenticating the user purchasing fuel via the fuel dispenser machine 420.

In some embodiments, the authentication component may successfully authenticate the activity 402 based on the authentication state 411. For example, the authentication component may identify the user carrying the smartphone 406 to the vehicle 408 based on the activity data 410 including GPS data indicative of the location 414 and/or biometric data of the user including height data, weight data, size data, and/or motion data. Further, the authentication component may successfully authenticate the activity 404 to purchase fuel based on the successful authentication of the activity 402 and the second authentication state 413.

In some embodiments, the second authentication state 413 may indicate an authentication level below the approximate 35-65% authentication level to authenticate the second activity 404 of purchasing fuel. In some instances, the authentication component may determine the authentication includes a failed authentication of the second activity 404, possibly due to the thief's attempts as described above lowering the authentication level of the authentication state 413. Yet, in some instances, additional data may be requested from the user to authenticate the second activity 404. In some instances, the user may enter a zip code to the fuel dispenser machine 420 and/or the smartphone 406 to authenticate the second activity 404 and purchase the fuel. Yet, in some instances, the user may provide biometric data such as fingerprint data via the fuel dispenser machine 420 and/or the smartphone 406 to authenticate the second activity 404 and purchase the fuel. In addition, the authentication component may determine a successful authentication of the second activity 404 based at least on the biometric data and the authentication state 413.

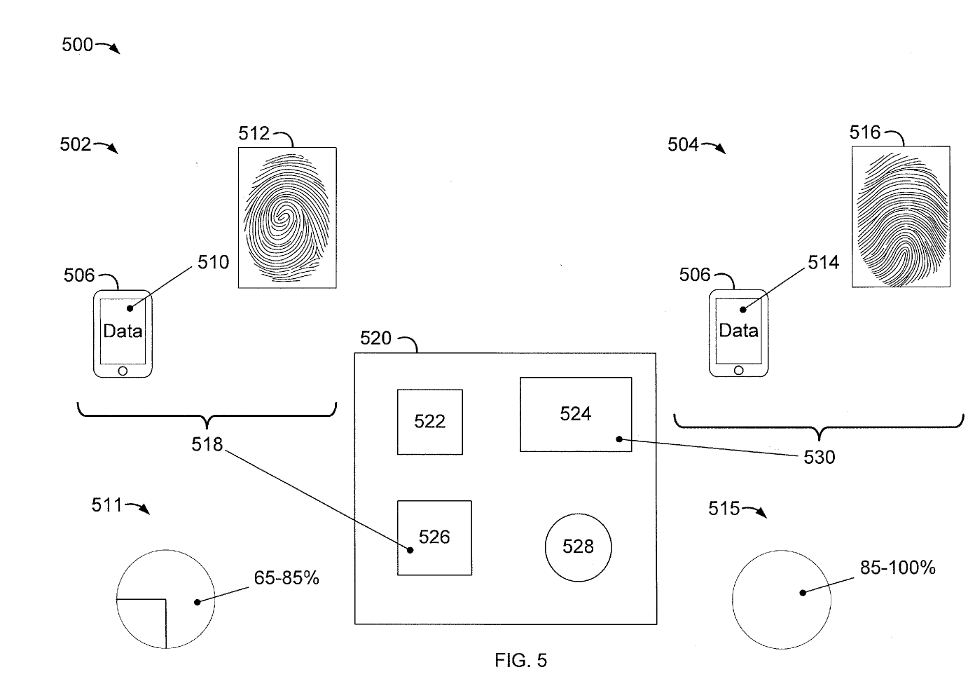

FIG. 5 is an exemplary system 500, according to an embodiment. As shown, activities 502 and 504 may involve client device 506. For example, considering one or more of the scenarios above, the system 500 may determine an activity 502 of a user carrying the client device 506 such as a smartphone proximate to structures 522, 524, 526, and/or 528 provided on a map 520 for illustrative purposes. In some instances, based on the authentication states 511 and 515, various stores in the structures 520, 522, 524, and/or 526 may allow purchases from the user's account using biometric data. For example, the stores may allow purchases by receiving data corresponding to a single thumbprint from the user, thereby circumventing the need for providing/carrying various cards, codes, and/or other forms of account data.

The client device 506 may, for example, take the form of any of the client devices 104 and 106, respectively, described above in relation to FIGS. 1-2B. For example, the client device 506 may take the form of client devices 104 and/or 106. Thus, the data 510 and 514 may be displayed on the user interfaces 130 and/or 140, respectively. The user interfaces 130 and 140 may include display components configured to display the data 510 and 514, respectively.

In some embodiments, the system 500 may include one or more non-transitory computer-readable mediums described above in relation to FIGS. 1-4. Further, the system 500 may include a communication interface, a transceiver, a processor, data storage, and/or an authentication circuit/component of a server device that may take the form of the communication interfaces 112 and/or 232, the transceivers 114 and/or 234, the processors 116 and/or 236, the data storage 118 and/or 238, and/or the authentication circuit/component 120 and/or 240 of the server devices 100 and/or 200, respectively, described above in relation to FIGS. 1-2.

In some embodiments, a non-transitory computer-readable medium of the system 500 may have stored thereon machine-readable instructions. Further, when executed by a server device of the system 500, the instructions may cause the server device to perform operations. In some instances, various operations may include receiving, by a communication interface of the server device, activity data 510 associated with an activity 502 of an account, where the activity data 510 includes a request to access the account and biometric data 512 to authenticate the request. As such, the activity data 510 may include biometric data 512 such as fingerprint data of the user to authenticate the activity 502.

In some embodiments, various operations may include determining, by an authentication component of the server device, a prior authenticated request to access the account within a time period. For example, the authentication component may determine the prior authenticated request from the activity data 310, 314, 410, and/or 412 described above in relation to FIGS. 3-5. For instance, the authentication component may determine the prior authenticated request from the activity data 412 for accessing the account and purchasing fuel via the fuel dispenser machine 420. As such, the prior authenticated request from the activity data 412 may be within the time period between the time of activity 404 and the time of activity 502.

In some embodiments, various operations may include determining, by an authentication component of the server device, an authentication state 511 of the account based on at least one of the prior authenticated request and the biometric data 512. As shown, the authentication state 511 may be represented with approximately 65-85% of the pie chart filled indicating a higher authentication level. In some instances, the authentication state 511 may include the authentication levels from authentication state 413 described above in relation to FIG. 4 and additional authentication levels.

Further, various operations may include determining, by the authentication component, an authentication of the request to access the account based at least on the authentication state 511 of the account. Yet further, various operations may include transmitting, by a transceiver of the communication interface, an indication of the authentication of the request to access the account to a client device such as the user's smartphone. In addition, the indication of the authentication may be transmitted to a merchant device at one or more of the stores in structures 522, 524, 526, and/or 528.

In some embodiments, determining the authentication of the activity 502 may include determining a successful authentication of the activity 502 based at least on the authentication state 511 of the account. For example, determining the successful authentication may include determining the authentication state 511 meets or exceeds an authentication level. Further, the authentication level may indicate an approximate 65-85% authentication level required to authenticate the activity 502. As such, the authentication state 511 may meet or exceed the approximate 65-85% authentication level to authenticate the activity 502. In some instances, the transceiver of the communication interface may transmit an indication of the successful authentication to a client device such as the smartphone 506.

In some embodiments, determining the authentication state 511 may include determining at least one of probability data, statistical data, and numeric data to authenticate the request to access the account. For example, the authentication component may determine one or more probabilities that the request is initiated, generated, and/or authenticated by an authorized user. Further, the authentication component may calculate statistics of the authorized user performing the activity 502 and/or initiating the request. Yet further, the authentication component may determine one or more numbers reflecting the authentication state 511 such as the approximate 65-85% authentication level to authenticate the activity 502 and/or the request.

In some embodiments, various operations may include determining, by the authentication component, the biometric data 512 includes fingerprint data. For example, determining the authentication state 511 of the account may be based at least on the fingerprint data. Further, the fingerprint data may include thumbprint data from the user's left thumb.

In some embodiments, determining the authentication state 511 may include determining a number of factors. For example, the authentication state 511 may be determined based on a current time, a current date, a current day of a week, a current month, a current season, a time of a future event, a date of the future event, a day of the future event, a month of the future event, and/or a season of the future event. In some instances, the authentication state 511 may indicate the approximate 65-85% authentication level based on the current time indicating a popular time for purchasing items from stores in the structure 526. Further, the authentication state 511 may be determined based on a time of a past event, a date of the past event, a day of the past event, a month of the past event, and/or a season of the past event.

In some embodiments, the authentication state 511 may be determined based on a current location 518, a past location, a future location 530, a location between the client device 506 and a user of the account, an ambient temperature, a weather forecast at the current location 518, a weather forecast proximate to a planned location of a planned event, a past weather forecast proximate to a past location of the past event, information on a calendar associated with the account, information accessible via a social networking account associated with the account, biometric statistics 512 associated with the account, noise level or any recognizable sounds detected by the client device 506, other client devices, the other client devices proximate to the client device 506, and the other client devices available to communicate with the server device.

In some embodiments, various operations may include determining a location 518 of the activity 502 based at least on the activity data 510. In some instances, the location 518 may include a historical location associated with the account and/or recorded/stored with the account. Further, determining the authentication state 511 of the account may be based on the historical location. Yet further, determining the authentication of the request to access the account may include determining a successful authentication of the request based at least on the authentication state 511.

In some embodiments, various operations may include receiving, by the communication interface, second activity data 514 associated with a second activity 504 of the account. In some instances, the second activity data 514 may include second biometric data 516. The activity data 510 and 514 may include store data of stores in structures 526 and 524, respectively, including store location data, store contact data such as a local address, an email address, a website URL, and/or a phone number. Yet further, the activity data 510 and 514 may include account data including purchasing data, invoice data, product data, shipping data, and/or other data related to the activities 502 and 504, respectively. In some instances, the operations may include determining, by the authentication component, a second authentication state 515 based on at least one of the authentication state 511 and the second biometric data 516. In some instances, the operations may include determining, by the authentication component, an authentication of the second activity 504 based at least on the second authentication state 515 of the account.

In some instances, the second biometric data 516 may include fingerprint data where determining the authentication state 515 of the account may be based at least on the fingerprint data. Further, the fingerprint data may include thumbprint data from the user's right thumb. In some instances, the fingerprint data may include thumbprint data from both the user's left thumb and right thumb.

In some embodiments, various operations may include determining, by the authentication component, the second authentication state 515 meets an authentication level. Further, determining the authentication of the second activity 504 may include determining the authentication of the second activity 504 is a successful authentication of the second activity 504 based at least on the second authentication state 515 meeting or exceeding the authentication level. For example, the authentication level may indicate an approximate 85-100% authentication level required to authenticate the activity 504. As such, the authentication state 515 may meet or exceed the approximate 85-100% authentication level to authenticate the activity 502. In some instances, the transceiver of the communication interface may transmit an indication of the successful authentication to a client device such as the smartphone 306 and/or a merchant device in one or more stores in the structure 524.

In some embodiments, the client device 506 may include and/or take the form of a wearable computing device with at least one of a head-mountable display and an atm-mountable display. In some instances, various operations may include causing the client device 506 to display an indication of the authentication with at least one of the head-mountable display and the arm-mountable display.

In some embodiments, various operations may include determining, by a processor of the server device, a first time of the activity 502 from the activity data 510 and a second time of the second activity 504 from the second activity data 508. In some instances, the activity data 510 and the second activity data 514 may include the first time and the second time, respectively, among the other forms of data described above.

Yet further, various operations may include determining, by the authentication component, the authentication state 515 based at least on the successful authentication of the first activity 502 and a time period between the first time and the second time. In some instances, the time period between the first time and the second time may be a few minutes, approximately less than an hour, a few hours, and/or longer periods of time. Yet, in some instances, the time period may be a few minutes for the system 500 to determine the authentication state 515 to successfully authenticate the second activity 504.

In some embodiments, various operations may include determining, by the authentication component, the authentication state 515 based at least on a relationship between the location 518 of the activity 502 and the second location 530 of the second activity 504. For example, the authentication state 511 may increase to the authentication level of the authentication state 515 based on the relationship between the first location 518 and the second location 530. Further, the authentication component may determine the authentication state 515 meets an authentication level and/or an authentication threshold to authenticate the second activity 504. Yet further, various operations may include determining, by the authentication component, the authentication is a successful authentication of the second activity 504 based at least on the authentication state 515.

In some embodiments, various operations may include determining, by a processor of the server device, a location 518 of the activity 502 from the activity data 510 and a second location 530 of the second activity 504 from the second activity data 514. In some instances, the location 518 and the second location 530 may include one or more historical locations and/or stored locations associated with the user's account. For example, the location 518 and the second location 530 may include a historical location such as a shopping mall location, a shopping center location, a recreational park location, and/or another location associated with the account. The historical location may be associated with historical activities including prior requests previously authenticated for the user's account. In some instances, various operations may include determining, by the authentication component, the second authentication state 515 to authenticate the second activity 504 based at least on the one or more historical locations possibly including the locations 518 and/or 530. Further, various operations may include determining, by the authentication component, the authentication is a successful authentication of the second activity 504 based at least on the second authentication state 515.

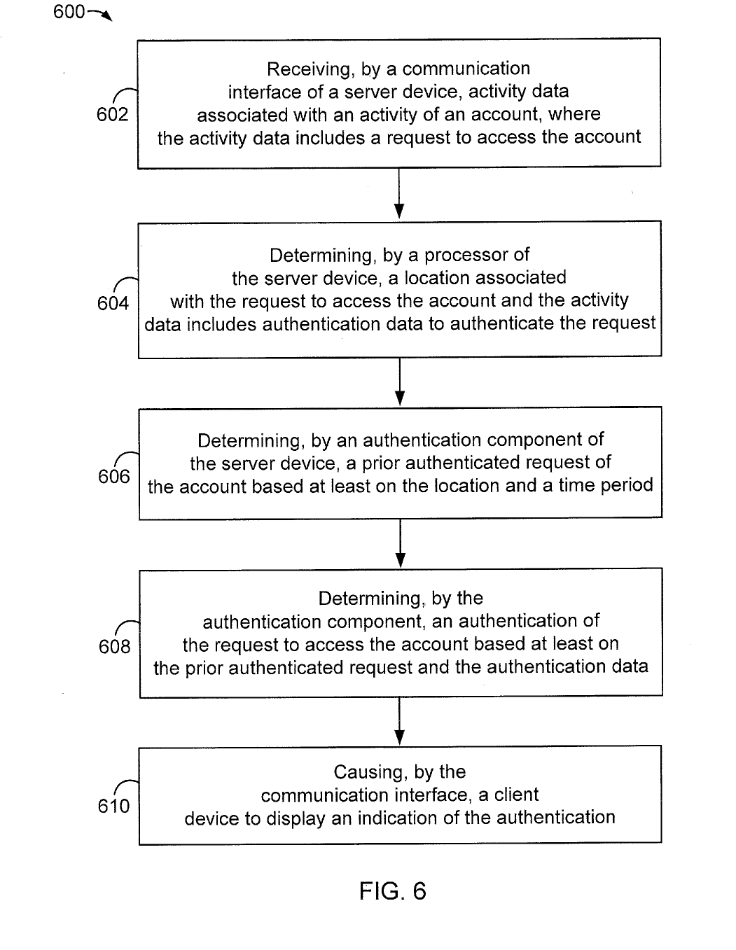

FIG. 6 is a flowchart of an exemplary method 600 for determining an authentication of a request to access an account, according to an embodiment. Note that one or more steps, processes, and methods described herein may be omitted, performed in a different sequence, and/or combined for various types of applications.

At step 602, the method 600 includes receiving, by a communication interface of a server device, activity data associated with an activity of an account, where the activity data includes a request to access the account. For example, the communication interface of the server device may take the form of the communication interfaces 112 and/or 232 of the server devices 100 and/or 200, respectively, and/or other communication interfaces described above in relation to FIGS. 1-5. In some instances, the communication interface may receive the activity data 510 associated with the activity 5302 of an account. Further, the activity data 510 may include the request to access the account.

At step 604, the method 600 includes determining, by a processor of the server device, a location associated with the request to access the account and the activity data includes authentication data to authenticate the request. In some instances, the processor may determine the location 518 associated with the request to access the account. For example, the processor of the server device may take the form of the processors 116 and/or 236 of the server devices 100 and/or 200, respectively, and/or other processors described above in relation to FIGS. 1-5. In some instances, the processor may determine the activity data 410, 412, 510, and/or 514 includes authentication data to authenticate the requests to access the account for activities 402, 404, 502, and/or 504, respectively. Further, the processor may determine the activity data 510 and 514 includes authentication data 512 and 516, respectively, to authenticate the activities 502 and 504, respectively

At step 606, the method 600 includes determining, by an authentication component of the server device, a prior authenticated request of the account based at least on the location and a time period. For example, the authentication component of the server device may include the authentication circuit/component 120 and/or 240 of the server devices 100 and/or 200, respectively, and/or other authentication circuits and/or components described above in relation to FIGS. 1-5. In some instances, the authentication component may determine the prior authenticated request based on the location 518. Referring back to FIG. 4, the authentication component may determine the prior authenticated request from the activity 404 of accessing the account to purchase fuel via the fuel dispenser machine 420. As such, the authentication component may determine the prior authenticated request based on a time period after the activity 404. In some instances, the authentication component may determine the authentication states 411, 413, 511, and/or 515 of the account based on the activity data 410, 412, 510, and/or 514. Further, the authentication component may determine the authentication states 411, 413, 511, and/or 515 of the account based on the authentication data in activity data 410 and/or 412, activity data 510 and/or 514, and/or other authentication data in FIGS. 4-5.

At step 608, the method 600 includes determining, by the authentication component, an authentication of the request to access the account based at least one the prior authenticated request and the authentication data. For example, the authentication component may determine an authentication of the request based on the prior authenticated request from the activity 404 and the authentication data including biometric data 516. In some instances, the authentication component may determine the authentications of the activities 402, 404, 502, and/or 504 based on the authentication states 411, 413, 511, and/or 515. For example, the authentication states 411, 413, 511, and/or 515 may meet and/or exceed respective authentication levels to authenticate the activities 402, 404, 502, and/or 504, respectively.

At step 610, the method 600 includes causing, by the communication interface, a client device to display an indication of the authentication. For example, the client device may take the form of client devices 406, 420, 506, and/or other client devices described above in relation to FIGS. 1-5. As noted, the client device may take the form of a merchant device, e.g., a tablet device in a merchant store that displays indications of the authentications.

In some embodiments, the method 500 may include determining an authentication state based on at least one of the prior authenticated request of the account and the authentication data. As noted, the authentication component may determine the prior authenticated request from the activity 404. In some instances, determining the authentication state may include determining at least one of probability data, statistical data, and/or numeric data to authenticate the request to access the account. For example, the authentication component may determine one or more probabilities that the activities 502 and/or 504 are carried out by an authorized user. Further, the authentication component may calculate statistics of the user performing the activities 502 and/or 504 at the locations 518 and/or 530, respectively. Yet further, the authentication component may determine one or more numbers or values reflecting the authentication states 511 and/or 515 such as the approximate authentication levels required to authenticate the activities 502 and/or 504. In some instances, determining the authentication of the request to access the account may include determining a successful authentication of the activities 502 and/or 504 based at least on the authentication states 511 and/or 515, respectively.

In some embodiments, the method 600 may include receiving, by the communication interface, second activity data 514 associated with a second activity 504 of the account. Further, the method 600 may include determining, by the authentication component, a second authentication state 515 based on at least one of the authentication state 511 and the second activity data 514. Yet further, the method 600 may include determining, by the authentication component, an authentication of the second activity 504 based at least on the second authentication state 515 of the account.

In some embodiments, the method 600 may include determining one or more forms of biometric data to authenticate activities of the account based at least on the second authentication state 515 of the account. Yet further, the method 600 may include determining the one or more forms of biometric data to authenticate activities of the account based on one or more of authentication states 411, 413, 511, 515, and/or other authentication states described above in relation to FIGS. 1-6. In some instances, the server device may require authentication data to authenticate activities of the account. For example, a given sever device may require a PIN number, a zip code, biometric data 512 and/or 516, and/or other authentication data to authenticate one or more activities of the account.

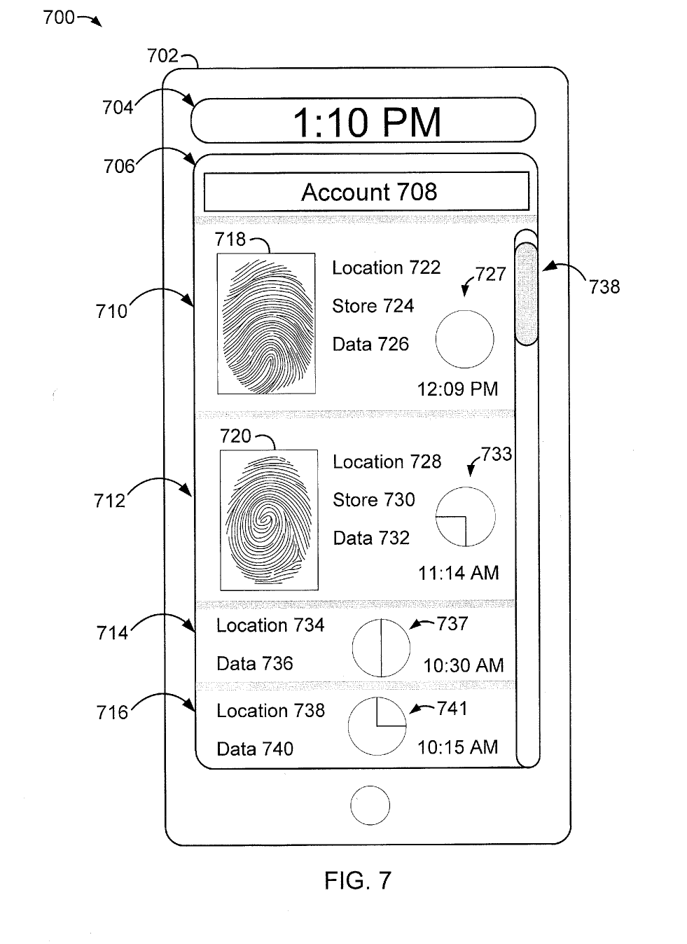

FIG. 7 provides an exemplary client device 700 with a user interface 702, according to an embodiment. In some instances, the client device 700 may take the form of client devices 306, 308, 406, 506, and/or other client devices described above in relation to FIGS. 1-6. Further, the client device 700 may take the form of one or more other user devices and/or merchant devices that displays indications of authentications of account activities and/or requests to access accounts.

As shown, the user interface 702 displays a time 704 indicating a current time of “1:10 PM.” Further, the user interface 702 displays activity data 706 of an account 708. For example, considering one or more scenarios above, the account 708 may be the user's account. Yet further, the account 708 may be a joint account of the user and the user's spouse, child, friend, colleague, and/or other related individuals to the user. As such, various account activities of the user may be displayed through the activity data 706.

In some embodiments, the user interface 702 displays activity data 710 that may take the form of the activity data 514 described above in relation to FIG. 5. Further, the activity data 710 may represent an authenticated request to access the account 708. The activity data 710 may include biometric data 718 that may take the form of the biometric data 516. The activity data 710 may include location data 722 that may indicate the location 530. The activity data 710 may include store data 724 that indicates a store in the structure 524. The activity data 710 may include data 726 of various details of one or more purchases made at the store in the structure 524. As shown, the activity data 710 may also include an indication of the time of the purchase(s) as “12:09 PM.” Further, the activity data 710 may include the authentication state 727 that may take the form of the authentication state 515. The authentication state 727 may be determined based on the location data 722, the store data 724, the purchase data 726, the time of the purchases, prior authenticated requests, and/or other account data.

In some embodiments, the user interface 702 displays activity data 712 that may take the form of the activity data 510. Further, the activity data 712 may represent an authenticated request to access the account 708. The activity data 712 may include biometric data 720 that may take the form of the biometric data 512. The activity data 712 may include location data 728 that may indicate the location 518. The activity data 712 may include store data 730 that indicates the store in the structure 526. The activity data 712 may include data 732 of various details of one or more purchases made at the store in the structure 526. As shown, the data 712 may also include an indication of the time of the purchase(s) as “11:14 AM.” Further, the activity data 712 may include the authentication state 733 that may take the form of the authentication state 511. The authentication state 733 may be determined based on the location data 728, the store data 730, the purchase data 732, the time of the purchases, prior authenticated requests, and/or other account data.

In some embodiments, the user interface 702 displays activity data 714 that may take the form of the activity data 412. Further, the activity data 714 may represent an authenticated request to access the account 708. The activity data 714 may include location data 734 that may indicate the location 418 of the gas station and/or the fuel dispenser machine 420. The activity data 714 may include data 736 indicating various details of the fuel purchased via the fuel dispenser machine 420. As shown, the data 714 may include the time of the purchase as “10:30 AM.” Further, the activity data 714 may include the authentication state 737 that may take the form of the authentication state 413. The authentication state 737 may be determined based on the location data 734, the purchase data 736, the time of the purchase, prior authenticated requests, and/or other account data.

In some embodiments, the user interface 702 displays activity data 716 that may take the form of the activity data 410. Further, the activity data 716 may represent an authenticated request to access the account 708. The activity data 716 may include location data 738 that may indicate the location 414, possibly the shopping mall location and/or the location of the vehicle 408 in the shopping mall parking lot. The activity data 716 may include data 740 indicating various details of authenticating the user as the driver of the vehicle 408. As shown, the activity data 716 may include the time, “10:15 AM,” possibly indicating the time at which the client device 406 proximately senses the vehicle 308. Further, the activity data 716 may include the authentication state 741 that may take the form of the authentication state 411. The authentication state 741 may be determined based on the location data 738, the purchase data 740, the time the client device 406 proximately senses the vehicle 408, prior authenticated requests, and/or other biometric data such as height data. In addition, the user interface 702 includes the scroll 738 to view various other activities associated with the account 708.

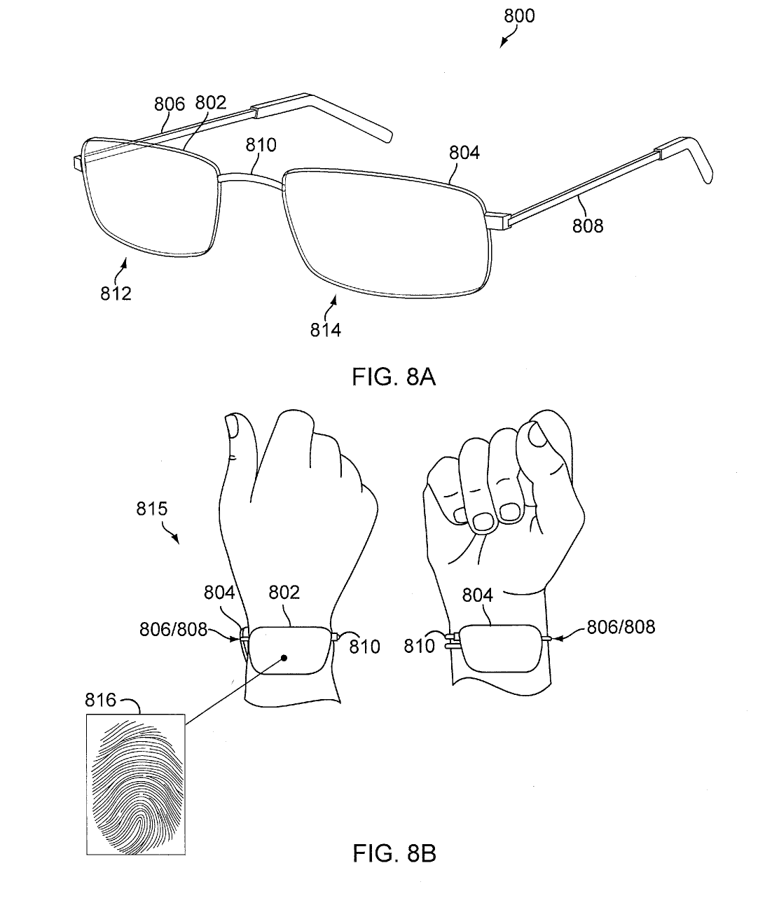

FIGS. 8A and 8B provide an exemplary client device 800, according to an embodiment. The client device 800 may take the form of the client device 700 and/or other client devices described above in relation to FIGS. 1-7. As shown, the client device 800 may take the form of a wearable computer. The client device 800 may include a wearable computing device with at least one of a head-mountable display and an arm-mountable display. As shown in FIG. 8A, the client device 800 may take the form of a head-mountable display/device (HMD). The client device 800 may include lenses 802 and 804. The client device 800 may also include a side component 806, a side component 808, and a middle component 810. For example, the computing device 800 may be mountable on a user's head such that the side component 806 rests on one ear of the user and the side component 808 rests on the other ear of the user. Further, the middle component 810 may rest on the nose of the user. In some instances, the lenses 802 and 804 may be positioned in front of the user's eyes. Further, the lenses 802 and 804 may include displays 812 and 814, respectively. In some instances, the displays 812 and 814 may be transparent, partially see-through, and/or configured to provide an augmented reality. Further, the displays 812 and/or 814 may include touch sensing displays including a fingerprint sensor.

As shown in FIG. 8B, the client device 800 may take the form of an arm-mountable device. For example, the side components 806 and 808, the middle component 810, and/or the lenses 802 and 804 may be adjustable to fit/mount on an arm and/or wrist 815 of a user. As shown, the lens 802 may be mounted/positioned on the top of the wrist 815. The side components 806, 808, and/or the middle component 810 may be adjusted to fit around the wrist 815. The lens 804 may be mounted/positioned on the bottom of the wrist 815. In some instances, the displays 802 and 804 may include fingerprint sensors configured to receive biometric data 816. As shown, the lens 802 may be configured to receive the biometric data 816, e.g., fingerprint data, that may take the form of the biometric data 516 and/or other biometric data described above in relation to FIGS. 1-7. Further, the lenses 802 and/or 804 may include scanners such as laser scanners configured to scan the eyes of the user to retrieve biometric data from the user's eyes, retinas, and/or irises. Yet further, the lenses 802 and/or 804 may be configured to detect one or more patterns of pulses from the wrist 815 of the user.

As noted above, the client device 506 may include and/or take the form of the wearable computing device 800 with at least one of a head-mountable display and an arm-mountable display. In some instances, various operations may include causing the client device 506 to display an indication of the authentication with at least one of the head-mountable display and the arm-mountable display. For example, the indication may be displayed on the lenses 802 and/or 804.

In some instances, referring back to FIG. 6, the method 600 may include causing the client device to display the indication of an authentication and/or authentication states. For example, the client device 800 may display indications of authentications and/or authentication states. As noted, for example, the authentication component of the server may determine authentications of various activities. In some instances, the method 600 may include causing the client device 800 to display the indication of the authentications and/or authentication states. As shown, the displays 812 and/or 814 may display the indication of the authentications of requests and/or authentication states to a user wearing the client device 800.

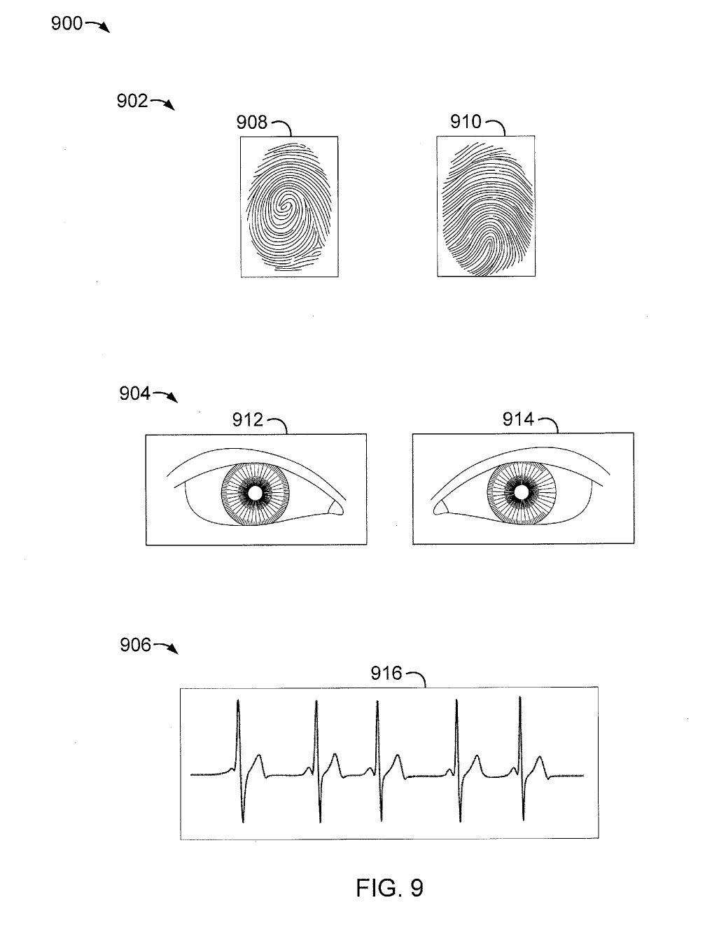

FIG. 9 is an illustration of one or more forms of biometric data 900, according to an embodiment. As shown, one or more forms of biometric data 900 may include biometric data 902 that includes biometric data 908 and/or 910. For example, the biometric data 908 and 910 may take the form of the biometric data 512 and 516, respectively, described above in relation to FIG. 5. Further, the biometric data 902 may include fingerprint data of a left finger and the biometric data 904 may include fingerprint data of a right finger. Further, as shown, one or more forms of biometric data 900 may include biometric data 904 that includes biometric data 912 and/or 914. For example, the biometric data 912 may include eye and/or iris data of a left eye and the biometric data 914 may include eye and/or iris data of a right eye. In addition, as shown, one or more forms of biometric data 900 may include biometric data 906 that includes biometric data 916. For example, biometric data 916 may include pulse data, possibly detectable from a user's wrist and/or head.

In some embodiments, a system may determine one or more forms of biometric data. In some instances, the system may include a communication interface, a transceiver, a processor, data storage, and/or an authentication circuit/component of a server device that may take the form of the communication interfaces 112 and/or 232, the transceivers 114 and/or 234, the processors 116 and/or 236, the data storage 118 and/or 238, and/or the authentication circuit/component 120 and/or 240 of the server devices 100 and/or 200, respectively, described above in relation to FIGS. 1-2B. Further, the system may determine the one or more forms of biometric data using one or more other circuits/components described above in relation to FIGS. 1-8. For example, the system may determine the one or more forms of biometric data via the client device 800 that may take the form of a head-mountable device and/or an arm-mountable device.

In some embodiments, a system may include a communication interface of a server device with means for receiving activity data associated with an activity of an account, wherein the activity data comprises a payment request for a transaction between a user of the account and a merchant. The system may also include a processor of the server device with means for determining a location associated with the payment request based at least on the activity data. The system may also include an authentication component of the server device with means for accessing prior authenticated requests of the account. The authentication component may include means for determining a prior authenticated request of the account based at least on the location and a time period. The authentication component may include means for determining an authentication of the payment request based at least on the prior authenticated request and an authentication input. The system may include a transceiver of the communication interface with means for transmitting an indication of the authentication to a client device.

In some embodiments, a system may include a non-transitory computer-readable medium having stored thereon machine-readable instructions that, when executed by a server device, cause the server device to perform operations. The system may include a communication interface of the server device with means for receiving activity data associated with an activity of an account, wherein the activity data comprises a request to access the account and biometric data to authenticate the request. The system may include an authentication component with means for determining a prior authenticated request to access the account within a time period. The authentication component may include means for determining an authentication state of the account based on at least one of the prior authenticated request and the biometric data. The authentication component may include means for determining an authentication of the request to access the account based at least on the authentication state of the account. The system may include a transceiver of the communication interface with means for transmitting an indication of the authentication of the activity to a client device.

The above details description describes various features and functions of the disclosed systems, devices, mediums, and/or methods with reference to the accompanying figures. It should be readily understood that the aspects of the present disclosure, as generally described herein, and illustrated in the figures, can be arranged, substituted, combined, separated, and designed in a wide variety of different configurations, all of which may be contemplated herein.

With respect to any or all of the message flow diagrams, scenarios, and flow charts in the figures and as discussed herein, each step, block and/or communication may represent processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage media.

The computer-readable medium may also include non-transitory computer-readable media such as media that stores data for short periods of time like register memory, processor cache, and/or random access memory (RAM). The computer-readable medium may also include non-transitory computer-readable media such as media that may store program code and/or data for longer periods of time, such as secondary or persistent long term storage, like read-only memory (ROM), optical or magnetic disks, and/or compact-disc read only memory (CD-ROM), for example. Thus, various forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read. Moreover, a step or block that represents one or more information transmissions may correspond to information transmissions between software and/or hardware modules in the same physical device. Further, other information transmissions may be between software modules and/or hardware modules in different physical devices.

In various embodiments of the present disclosure, execution of instruction sequences to practice the present disclosure may be performed by a computer system. In various other embodiments of the present disclosure, a plurality of computer systems coupled by a communication link to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure and the accompanying figures may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system, comprising:
a communication interface of a server device that receives activity data associated with an activity of an account, wherein the activity data comprises a payment request for a transaction between a user of the account and a merchant;
a processor of the server device that determines a location associated with the payment request based at least on the activity data;
an authentication component of the server device that:
accesses prior authenticated requests of the account;
determines a prior authenticated request of the account based at least on the location and a time period; and
determines an authentication of the payment request based at least on the prior authenticated request and an authentication input; and
a transceiver of the communication interface that transmits an indication of the authentication to a client device.

2. The system of claim 1, wherein the authentication input comprises at least one of biometric data, fingerprint data, eye data, voice data, height data, weight data, and body data.

3. The system of claim 1, wherein the processor of the server device determines a time associated with the payment request based at least on the activity data, wherein the authentication component determines the time is within the time period associated with the prior authenticated request, and wherein the authentication component determines the authentication of the payment request based on the determination of the time within the time period.

4. The system of claim 1, wherein the authentication component determines the time period based on at least one of an estimated time period for the user to shop at the location, an event at the location, a prior event at the location, a number of merchants at the location, calendar data associated with the location, sales of merchants at the location, and a current time of a year.

5. The system of claim 1, wherein the authentication component determines the location associated with the payment request comprises a historical location associated with the account, wherein the authentication component determines the authentication of the payment request based at least on the historical location, and wherein the authentication component determines the authentication comprises a successful authentication of the payment request.

6. The system of claim 1, wherein the authentication component determines the location associated with the payment request comprises a new location associated with the account, wherein the authentication component determines the authentication of the payment request based at least on the new location, and wherein the authentication component determines the authentication comprises a failed authentication of the payment request.

7. The system of claim 1, wherein the communication interface receives second activity data associated with a second activity of the account, wherein the authentication component determines an authentication state based on at least one of the location, the time period, and the second activity data, and wherein the authentication component determines an authentication of the second activity based at least on the authentication state of the account.

8. A non-transitory computer-readable medium having stored thereon machine-readable instructions that, when executed by a server device, cause the server device to perform operations comprising:
receiving, by a communication interface of the server device, activity data associated with an activity of an account, wherein the activity data comprises a request to access the account and biometric data to authenticate the request;
determining, by an authentication component, a prior authenticated request to access the account within a time period;
determining, by an authentication component of the server device, an authentication state of the account based on at least one of the prior authenticated request and the biometric data;
determining, by the authentication component, an authentication of the request to access the account based at least on the authentication state of the account; and
transmitting, by a transceiver of the communication interface, an indication of the authentication of the request to access the account to a client device.

9. The non-transitory computer-readable medium of claim 8, wherein determining the authentication of the activity comprises determining a successful authentication of the activity based at least on the authentication state.

10. The non-transitory computer-readable medium of claim 8, wherein determining the authentication state comprises determining at least one of probability data, statistical data, and numeric data to authenticate the request to access the account.

11. The non-transitory computer-readable medium of claim 8, the operations comprising determining, by the authentication component, the biometric data comprises fingerprint data, wherein determining the authentication state of the account is based at least on the fingerprint data.

12. The non-transitory computer-readable medium of claim 8, wherein determining the authentication state comprises determining at least one of the following: (a) a current time, (b) a current date, (c) a current day of a week, (d) a current month, (e) a current season, (f) a time of a future event, (g) a date of the future event, (h) a day of the future event, (i) a month of the future event, (j) a season of the future event, (k) a time of a past event, (l) a date of the past event, (m) a day the past event, (n) a month of the past event, (o) a season of the past event, (p) a current location, (q) a past location, (r) a future location, (s) a location between the client device and a user of the account, (t) an ambient temperature, (u) a weather forecast at the current location, (v) a weather forecast proximate to a planned location of a planned event, (w) a past weather forecast proximate to a past location of the past event, (x) information on a calendar associated with the account, (y) information accessible via a social networking account associated with the account, (z) biometric statistics associated with the account, (aa) noise level or any recognizable sounds detected by the client device, (bb) other client devices, (cc) the other client devices proximate to the client device, and (dd) the other client devices available to communicate with the server device.

13. The non-transitory computer-readable medium of claim 8, the operations comprising determining a location of the activity based at least on the activity data, wherein the location comprises a historical location associated with the account, wherein determining the authentication state of the account is based at least on the historical location, and wherein determining the authentication of the request to access the account comprises determining a successful authentication of the request to access the account based at least on the authentication state.

14. The non-transitory computer-readable medium of claim 8, the operations comprising:
receiving, by the communication interface, second activity data associated with a second activity of the account, wherein the second activity data comprises second biometric data;
determining, by the authentication component, a second authentication state based on at least one of the authentication state and the second biometric data; and
determining, by the authentication component, an authentication of the second activity based at least on the second authentication state of the account.

15. The non-transitory computer-readable medium of claim 14, the operations comprising determining, by the authentication component, the second authentication state meets an authentication level, and wherein determining the authentication of the second activity comprises determining the authentication of the second activity is a successful authentication of the second activity based at least on the second authentication state.

16. The non-transitory computer-readable medium of claim 8, wherein the client device comprises a wearable computing device with at least one of a head-mountable display and an arm-mountable display, the operations comprising causing the client device to display an indication of the authentication with at least one of the head-mountable display and the arm-mountable display.

17. A method, comprising:
receiving, by a communication interface of a server device, activity data associated with an activity of an account, wherein the activity data comprises a request to access the account;
determining, by a processor of the server device, a location associated with the request to access the account and the activity data comprises authentication data to authenticate the request;
determining, by an authentication component of the server device, a prior authenticated request of the account based at least on the location and a time period;
determining, by the authentication component, an authentication of the request to access the account based at least on the prior authenticated request and the authentication data; and
causing, by the communication interface, a client device to display an indication of the authentication.

18. The method of claim 17, comprising determining an authentication state based on at least one of the prior authenticated request of the account and the authentication data, and wherein determining the authentication state comprises determining at least one of probability data, statistical data, and numeric data to authenticate the request to access the account, and wherein determining the authentication of the request to access the account comprises determining a successful authentication of the activity based at least on the authentication state.

19. The method of claim 17, comprising:
receiving, by the communication interface, second activity data associated with a second activity of the account;
determining, by the authentication component, a second authentication state based on at least one of the authentication state and the second activity data; and
determining, by the authentication component, an authentication of the second activity based at least on the second authentication state of the account.

20. The method of claim 19, comprising determining one or more forms of biometric data to authenticate activities of the account based at least on the second authentication state of the account.
